(19) United States
(12) Patent Application Publication
(10) Pub. No.: US 2014/0144160 A1
(43) Pub. Date: May 29, 2014

(54) HV BATTERY THERMAL CONTROL SYSTEM AND METHOD

(71) Applicant: Kenneth J. Jackson, Dearborn, MI (US)

(72) Inventor: Kenneth J. Jackson, Dearborn, MI (US)

(21) Appl. No.: 13/684,548

(22) Filed: Nov. 25, 2012

(51) Int. Cl. H01M 10/50; F25B 39/02; B60H 1/00; F25D 17/04

(52) U.S. Cl. CPC H01M 10/5004; F25D 17/04; F25B 39/02; B60H 1/00007
USPC 62/62; 429/120

(57) ABSTRACT

A battery thermal control system includes a battery, a heater core disposed in fluid communication with the battery and a vehicle HVAC system having an evaporator thermally interfacing with the heater core. A battery thermal control method is also disclosed.

### FIELD

Embodiments of the disclosure generally relate to systems and methods for controlling vehicle HV (High Voltage) battery coolant temperatures. More particularly, embodiments of the disclosure relate to an HV battery thermal control system and method in which an HV battery can be cooled by distributing battery coolant through a cooled auxiliary heater core.

### BACKGROUND

The capacity to enhance climate comfort in vehicles has increased over the years. New vehicle designs which are currently being developed, however, present new challenges for air conditioning technology. As electrification of vehicles expands to all vehicle classes, the complexity of managing thermal issues in climate control considerations grows. For vehicles with 3 rows of seating, auxiliary HVAC units may be used to better balance cabin comfort for all passengers. If such vehicles are electrified and the HV battery in the vehicle requires coolant below ambient temperatures, a 3rd evaporator in the form of a coolant chiller would normally be required. This, however, would require hardware that is expensive and difficult to package.

Accordingly, an HV battery thermal control system and method in which an HV battery can be cooled by distributing battery coolant through a cooled auxiliary heater core are needed.

### SUMMARY

The disclosure is generally directed to a battery thermal control system. An illustrative embodiment of the battery thermal control system includes a battery, a heater core disposed in fluid communication with the battery and a vehicle HVAC system having an evaporator thermally interfacing with the heater core.

The disclosure is further generally directed to a battery thermal control method. An illustrative embodiment of the method includes flowing ambient air through an evaporator of an HVAC system, distributing cooled air from the evaporator to an auxiliary heater core, distributing battery coolant through the auxiliary heater core and cooling the battery by distributing the battery coolant through the battery.

### BRIEF DESCRIPTION OF THE DRAWINGS

Embodiments of the disclosure will now be made, by way of example, with reference to the accompanying drawings, in which:

FIG. 1 is a schematic diagram of an illustrative embodiment of the HV battery thermal control system, more particularly illustrating a battery cooling operational mode of the system.

FIG. 1A is a schematic diagram of an illustrative embodiment of the HV battery thermal control system, more particularly illustrating a battery heating operational mode of the system.

FIG. 1B is a schematic diagram of an alternative illustrative embodiment of the HV battery thermal control system.

FIG. 1C is a schematic diagram of another alternative illustrative embodiment of the HV battery thermal control system.

FIG. 2 is a flow diagram of an illustrative embodiment of the HV battery thermal control method.

FIG. 3 is a system control flow chart which illustrates an exemplary control method for the HV battery thermal control system.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Moreover, the illustrative embodiments described herein are not exhaustive and embodiments or implementations other than those which are described herein and which fall within the scope of the appended claims are possible. Furthermore, there is no intention to be bound by any expressed or implied theory presented in the preceding technical field, background, brief summary or the following detailed description.

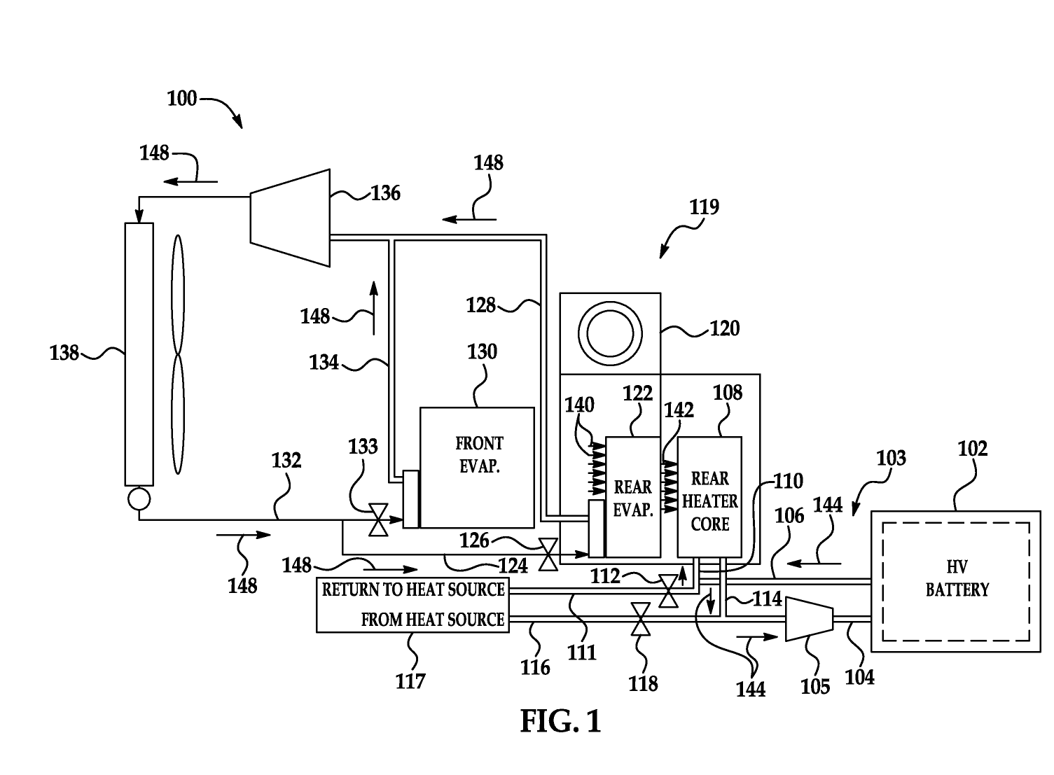

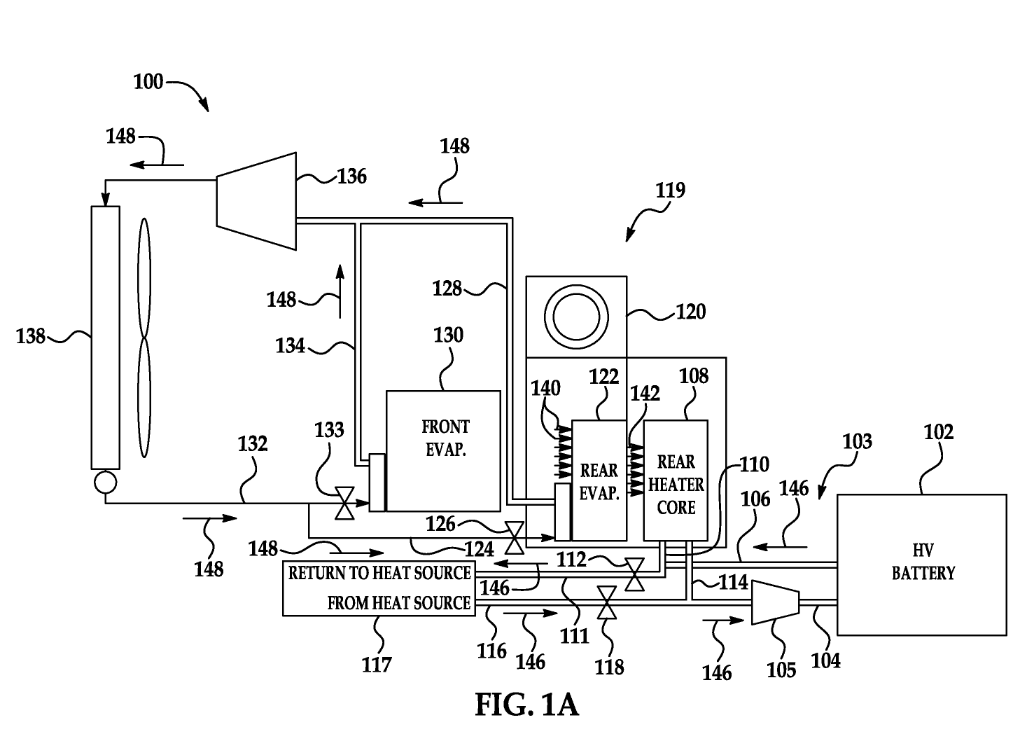

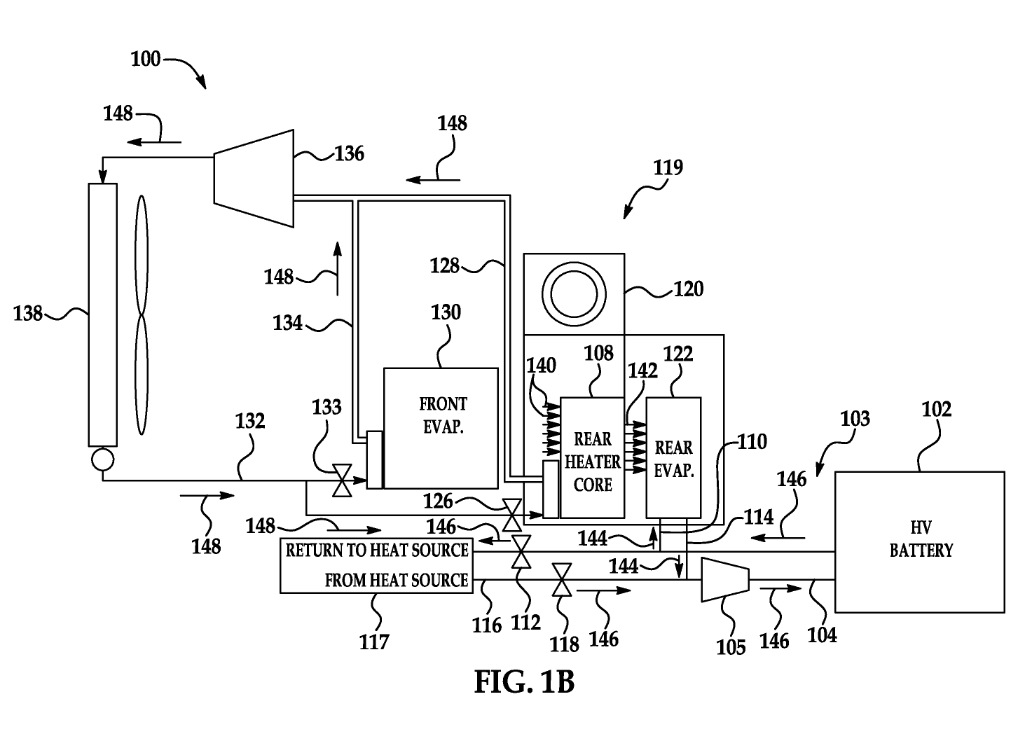

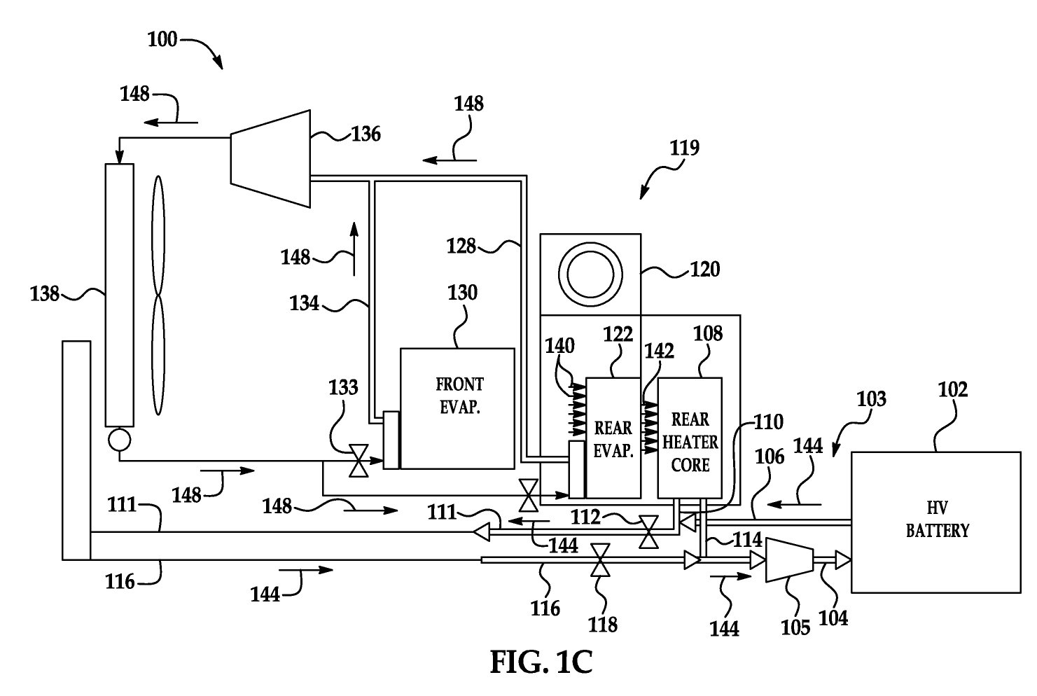

Referring initially to FIG. 1 of the drawings, an illustrative embodiment of the HV (High Voltage) battery cooling system, hereinafter system, is generally indicated by reference numeral 100. The system 100 includes an HV battery 102. The HV battery 102 may power at least some of the electrical components of a vehicle (not illustrated). In some applications, the vehicle may be a PHEV (Plug-in Hybrid Electric Vehicle). In some applications, the vehicle may be a large passenger vehicle having at least 2 rows of seating. Accordingly, an HVAC system 119 for the vehicle may have separate climate control components for the front seat and the rear seat or seats in the vehicle as is known by those skilled in the art.

The HV battery 102 is disposed in fluid communication with an auxiliary HVAC (Heating, Ventilation, Air Conditioning) heater core 108 through a battery coolant circuit 103. The auxiliary heater core 108 thermally interfaces with a rear evaporator 122 of a vehicle HVAC system 119 to facilitate selective cooling of the heater core 108, as will be hereinafter described. The vehicle HVAC system 119 may include a rear HVAC fan 120 which contains the rear evaporator 122. The rear evaporator 122 may be disposed in adjacent proximity to the auxiliary heater core 108. As will be hereinafter further described, by operation of the rear HVAC fan 120, ambient air 140 is drawn through the rear evaporator 122, where the ambient air 140 is cooled. The cooled air 142 from the rear evaporator 122 flows through and cools the auxiliary heater core 108.

An AC condenser 138 may communicate with the rear evaporator 122 through a rear evaporator inlet conduit 124 and a rear evaporator outlet conduit 128. A valve 126 may be included in the rear evaporator inlet conduit 124. A front evaporator 130 may communicate with the AC condenser 138 through a front evaporator inlet conduit 132 and a front evaporator outlet conduit 134. A valve 133 may be included in the front evaporator inlet conduit 132. An AC compressor 136 may be provided between the AC condenser 138 and the front evaporator 130 and the rear evaporator 122.

The battery coolant circuit 103 may include a battery coolant inlet conduit 104 and a battery coolant outlet conduit 106 which communicate with the HV battery 102 for the purpose of distributing battery coolant 144 (FIG. 1) through the HV battery 102, as will be hereinafter described. A battery coolant pump 105 may be included in the battery coolant inlet conduit 104. A heat source inlet conduit 116 may communicate with the battery coolant inlet conduit 104. A fluid heat source 117 such as a source of heated coolant 146 (FIG. 1A) from a vehicle engine (not shown) may communicate with the heat source inlet conduit 116. A valve 118 may be included in the heat source inlet conduit 116 to selectively close and block or open and facilitate flow of heated coolant 146 (FIG. 1A) from the fluid heat source 117 through the heat source inlet conduit 116.

The auxiliary heater core 108 communicates with the battery coolant inlet conduit 104 through a heater core outlet conduit 114. A heater core inlet conduit 110 communicates with the auxiliary heater core 108. A heat source return conduit 111 may communicate with the heater core inlet conduit 110. The heat source return conduit 111 may communicate with the fluid heat source 117 for purposes which will be hereinafter described. A valve 112 may be provided in the heat source return conduit 111 to selectively close and block or open and facilitate flow of heated coolant 146 (FIG. 1A) to the fluid heat source 117 through the heat source return conduit 111.

As illustrated in FIG. 1, in exemplary battery cooling operation of the system 100, under circumstances in which the HV battery 102 requires cooling, the valves 118, 112 are closed to prevent flow of heated coolant 146 (FIG. 1A) through the heat source inlet conduit 116 and the heat source return conduit 111, respectively. The vehicle HVAC system 119 is operated to circulate AC coolant 148 through the AC compressor 136, the AC condenser 138, the front evaporator 130 and the rear evaporator 122, typically in the conventional manner.

The rear HVAC fan 120 blows ambient air 140 through the rear evaporator 122. The cooled air 142 which emerges from the rear evaporator 122 flows through and cools the auxiliary heater core 108. Battery coolant 144 is pumped in a continuous loop from the HV battery 102 through the battery coolant outlet conduit 106, the heater core inlet conduit 110, the auxiliary heater core 108, the heater core outlet conduit 114 and back into the HV battery 102 through the battery coolant inlet conduit 104. As the battery coolant 144 circulates through the auxiliary heater core 108, thermal energy is transferred from the battery coolant 144 to the auxiliary heater core 108, cooling the battery coolant 144. Thermal energy continues to be transferred from the auxiliary heater core 108 to the cooled air 142 flowing from the rear evaporator 122, cooling the auxiliary heater core 108. As it subsequently flows through the HV battery 102, the battery coolant 144 cools the HV battery 102 by transfer of thermal energy from the HV battery 102 to the battery coolant 144.

Referring next to FIG. 1A of the drawings, in exemplary battery heating operation of the system 100, under circumstances in which heating of the HV battery 102 is desired, the valves 118, 112 may be opened. This facilitates circulation of heated coolant 146 from the heat source 117 through the heat source inlet conduit 116, the battery coolant inlet conduit 104, the HV battery 102, the battery coolant outlet conduit 106 and the heat source return conduit 111, respectively, back to the heat source 117. As the heated coolant 146 is circulated through the HV battery 102, transfer of thermal energy from the heated coolant 146 to the HV battery 102 occurs, heating the HV battery 102.

Referring next to FIG. 1B of the drawings, an alternative illustrative embodiment of the battery heating operation system is generally indicated by reference numeral 200. The system 200 may be similar in design to the system 100 which was heretofore described with respect to FIGS. 1 and 1A, except in the system 200, the auxiliary heater core 108 and the auxiliary evaporator 122 may be switched with respect to air flow. The heater core inlet conduit 110 and the heater core outlet conduit 114 may be disposed in fluid communication with the rear evaporator 122 to facilitate flow of battery coolant 144 through the rear evaporator 122. This configuration may enable the HV battery 102 to use cabin air and the heat from the HV battery 102 to be absorbed directly by the auxiliary evaporator 122. Accordingly, enhanced passenger cooling at a small loss of battery cooling may result.

Referring next to FIG. 1C of the drawings, another alternative illustrative embodiment of the battery heating operation system is generally indicated by reference numeral 300. The system 300 may be similar in design to the system 100 which was heretofore described with respect to FIGS. 1 and 1A, except in the system 300, the heat source return conduit 111 and the heat source inlet conduit 116 may be disposed in fluid communication with a coolant heat exchanger 150. The coolant heat exchanger 150 may be disposed in air flow proximity to the AC condenser 138. Accordingly, valve 112 may be configured such that the coolant flows through coolant heat exchanger 150, such that heat is dissipated from the battery coolant 144. The cooled battery coolant 144 flows from the coolant heat exchanger 150 through the heat source inlet conduit 116 and through the HV battery 102, cooling the HV battery 102. The battery coolant 144 then flows from the HV battery 102 through heat exchanger 150 via the battery coolant outlet conduit 106, and the process repeats. This enables cooling of the battery without operation of the air conditioning compressor 136.

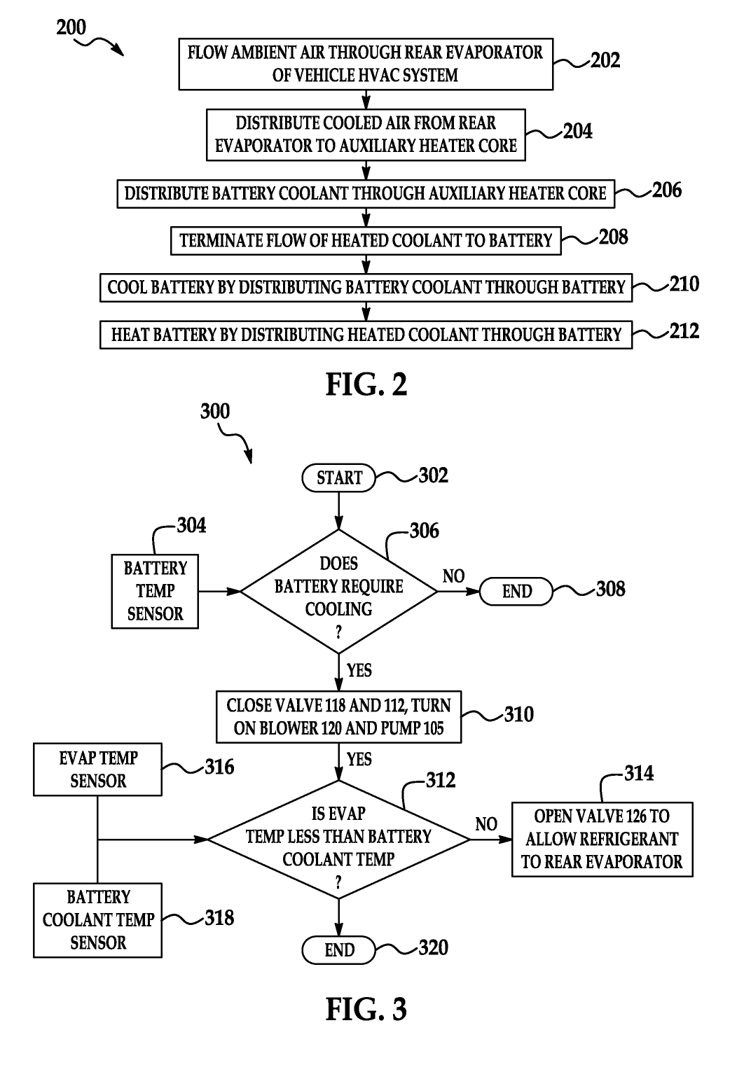

Referring next to FIG. 2 of the drawings, a flow diagram 200 of an illustrative embodiment of the HV battery thermal control method is shown. In block 202, ambient air flows through a rear evaporator of a vehicle HVAC system. In block 204, cooled air is distributed from the rear evaporator to an auxiliary heater core. In block 206, battery coolant is distributed through the auxiliary heater core. In block 208, flow of heated coolant to an HV battery may be terminated. In block 210, the HV battery is cooled by distributing the battery coolant through the battery. In block 212, in some applications, the battery may be heated by distributing vehicle engine coolant through the battery as an alternative to cooling the battery.

Referring next to FIG. 3 in conjunction with FIG. 1B of the drawings, a system control flow chart 300 which illustrates an exemplary control method for the HV battery thermal control system 200 is shown. The control method begins at block 302. At block 306, a battery temperature sensor 304 may determine whether the HV battery 102 requires cooling. If the HV battery 102 does not require cooling, the method may end at block 308.

If the battery temperature sensor 304 determines that the HV battery 102 does require cooling in block 306, then in block 310 the valves 112, 118 may be closed and the rear HVAC fan 120 and the battery coolant pump 105 turned on. In block 312, an evaporator temperature sensor 316 and a battery coolant temperature sensor 318 may determine whether the evaporator temperature of the rear evaporator 122 is less than the temperature of the battery coolant 144. If the evaporator temperature of the rear evaporator 122 is less than the temperature of the battery coolant 144, then the valve 126 may be opened to facilitate flow of refrigerant 148 to the rear evaporator 122. If the evaporator temperature of the rear evaporator 122 is not less than the temperature of the battery coolant 144, then the method may end at block 320.

Although the embodiments of this disclosure have been described with respect to certain exemplary embodiments, it is to be understood that the specific embodiments are for purposes of illustration and not limitation, as other variations will occur to those of skill in the art.

What is claimed is:

1. A battery thermal control system, comprising:
a battery;
a heater core disposed in fluid communication with said battery; and
a vehicle HVAC system having an evaporator thermally interfacing with said heater core.

2. The system of claim 1 further comprising a heat source inlet conduit and a heat source return conduit communicating with said battery.

3. The system of claim 2 further comprising a valve in each of said heat source inlet conduit and said heat source return conduit.

4. The system of claim 2 further comprising a fluid heat source communicating with said heat source inlet conduit and said heat source outlet conduit.

5. The system of claim 4 wherein said fluid heat source comprises a source of heated coolant.

6. The system of claim 5 wherein said fluid heat source comprises a source of heated vehicle engine coolant.

7. The system of claim 1 wherein said vehicle HVAC system comprises an AC compressor communicating with said evaporator and an AC condenser communicating with said AC compressor and said evaporator.

8. The system of claim 7 wherein said evaporator is positioned to receive air from said rear heater core.

9. The system of claim 1 further comprising a coolant heat exchanger disposed in fluid communication with said heater core.

10. A battery thermal control system, comprising:
a battery;
a heater core;
a battery coolant circuit having a battery coolant inlet conduit and a battery coolant outlet conduit establishing communication between said battery and said heater core; and
a vehicle HVAC system having an evaporator thermally interfacing with said heater core.

11. The system of claim 10 further comprising a heat source inlet conduit and a heat source return conduit communicating with said battery coolant inlet conduit and said battery coolant outlet conduit, respectively, of said battery coolant circuit.

12. The system of claim 11 further comprising a valve in each of said heat source inlet conduit and said heat source return conduit.

13. The system of claim 11 further comprising a fluid heat source communicating with said heat source inlet conduit and said heat source outlet conduit.

14. The system of claim 13 wherein said fluid heat source comprises a source of vehicle engine coolant.

15. The system of claim 10 wherein said vehicle HVAC system comprises an AC compressor communicating with said evaporator and an AC condenser communicating with said AC compressor and said evaporator.

16. The system of claim 15 wherein said evaporator is positioned to receive air from said rear heater core.

17. A battery thermal control method, comprising:
flowing ambient air through an evaporator of an HVAC system;
distributing cooled air from said evaporator to an auxiliary heater core;
distributing battery coolant through said auxiliary heater core; and
cooling said battery by distributing said battery coolant through said battery.

18. The method of claim 17 further comprising terminating flow of heated coolant to said battery.

19. The method of claim 17 further comprising heating said battery by distributing heated coolant through said battery as an alternative to said cooling said battery.

20. The method of claim 19 wherein said distributing heated coolant through said battery comprises distributing heated vehicle engine coolant through said battery.
